(19) United States
(12) Patent Application Publication
(10) Pub. No.: US 2018/0046724 A1
(43) Pub. Date: Feb. 15, 2018

(54) INFORMATION RECOMMENDATION METHOD AND APPARATUS, AND SERVER

(71) Applicant: Tencent Technology (Shenzhen) Company Limited, Shenzhen (CN)

(72) Inventors: Dapeng LIU, Shenzhen (CN); Xiaoqing CAO, Shenzhen (CN)

(21) Appl. No.: 15/791,259

(22) Filed: Oct. 23, 2017

Related U.S. Application Data
(63) Continuation of application No. PCT/CN2016/113895, filed on Dec. 30, 2016.

(30) Foreign Application Priority Data
Jan. 12, 2016 (CN) 201610019783.7

(51) Int. Cl. G06F 17/30; H04W 4/06; H04L 29/08; G06Q 50/00; G06F 17/10

(52) U.S. Cl. CPC G06F 17/30867; G06Q 50/01; G06F 17/10; H04L 67/22; H04W 4/06

(57) ABSTRACT

In some embodiments, an information recommendation method includes: determining a target friend who has interacted with target recommended information; determining data of interaction made by the target user with previously shared information published by the target friend; determining an influence degree of the target friend on interaction to be made by the target user with the target recommended information based on the data of interaction; determining a target influence degree based on the influence degree of the target friend on the interaction to be made by the target user with the target recommended information; determining a probability degree of the interaction to be made by the target user with the target recommended information based on the target influence degree; and pushing the target recommended information to the target user, if the probability degree meets a preset condition.

The present application is a continuation of International Patent Application No. PCT/CN2016/113895 filled on Dec. 30, 2016, which claims priority to Chinese Patent Application No. 201610019783.7, titled “INFORMATION RECOMMENDATION METHOD AND APPARATUS, AND SERVER”, filed on Jan. 12, 2016 with the State Intellectual Property Office of People's Republic of China, both of which are incorporated herein by reference in their entireties.

### TECHNICAL FIELD

The present disclosure relates to the technical field of information processing, and in particular to an information recommendation method, an information recommendation apparatus, and a server.

### BACKGROUND

With development of social applications, pushing recommended information, such as an advertisement and weather information, via the social application becomes a new approach for information service to provider recommend information to users. Similar to sharing information among one or more friends in the social application, the user can interact, such as making comments or giving the thumbs-up, with the recommended information such as the advertisement and the weather information pushed by the social application. To effectively push the recommended information, it is important to estimate probability that the user interacts, such as making comments or giving the thumbs-up, with the recommended information after the recommended information is pushed to the user. If the probability that the user interacts with the recommended information is higher, the interaction effect on the pushed recommended information is better.

At present, in pushing recommended information, normally an interest level of the user in the recommended information is measured based on a relevance degree between the user and the recommended information. If the interest level of the user on the recommended information is higher, the possibility that the user interacts with the recommended information is higher. Therefore, whether to push the recommended information to the user is determined on the basis of the interest level of the user on the recommended information.

### SUMMARY

In view of this, an information recommendation method, an information recommendation apparatus, and a server are provided according to embodiments of the present disclosure.

To achieve the above objective, the following technical solutions are provided according to an embodiment of the present disclosure.

An information recommendation method is provided, which includes:

determining a target friend who has interacted with target recommended information among one or more friends of a target user;

determining data of interaction made by the target user with previously shared information published by the target friend;

determining an influence degree of the target friend on interaction to be made by the target user with the target recommended information based on the data of interaction made by the target user with the previously shared information published by the target friend;

determining a target influence degree based on the influence degree of the target friend on the interaction to be made by the target user with the target recommended information;

determining a probability degree of the interaction to be made by the target user with the target recommended information based on the target influence degree; and

pushing the target recommended information to the target user, in a case that the probability degree meets a preset condition.

An information recommendation apparatus is further provided according to an embodiment of the present disclosure, which includes one or more processors and storage medium storing an operation instruction. the processor is configured to execute the operation instruction stored in the storage medium to perform following steps:

determining a target friend who has interacted with target recommended information among one or more friends of a target user;

determining data of interaction made by the target user with previously shared information published by the target friend;

determining an influence degree of the target friend on interaction to be made by the target user with the target recommended information based on the data of interaction made by the target user with the previously shared information published by the target friend;

determining a target influence degree based on the influence degree of the target friend on the interaction to be made by the target user with the target recommended information;

determining a probability degree of the interaction to be made by the target user with the target recommended information based on the target influence degree; and

pushing the target recommended information to the target user, in a case that the probability degree meets a preset condition.

A server is further provided according to an embodiment of the present disclosure, which includes the above information recommendation apparatus.

In the above technical solutions, based on a discovery that the rule of interaction to be made by a user with the shared information published by a friend is relevant to an influence of the friend on interaction to be made by the user with recommended information, in an embodiment of the present disclosure, the data of interaction made by the target user with the previously shared information published by the target friend is determined for the target friend among the one or more friends of the target user, who has interacted with the target recommended information. Then the influence degree of the target friend on the interaction to be made by the target user with the target recommended information is determined. Then the influence degree of each of the target friends on the interaction to be made by the target user with the target recommended information is integrated, to determine the target influence degree of the friend who has interacted with the target recommended information, on the interaction to be made by the target user with the target recommended information. The probability degree of the interaction to be made by the target user with the target recommended information is determined based on the target influence degree, for pushing the target recommended information. Because the influence degree of the friend on the interaction to be made by the target user with the target recommended information is referred to in determining the probability degree of the interaction to be made by the target user with the target recommended information in an embodiment of the present disclosure, accuracy of the determined probability that the user interacts with the recommended information is increased, so as to improve the effectiveness of pushing the recommended information.

### BRIEF DESCRIPTION OF THE DRAWINGS

FIG. 1 is a flowchart of an information recommendation method according to an embodiment of the present disclosure;

FIG. 2 is a flowchart of a method for determining an interaction weight and a preset constant according to an embodiment of the present disclosure;

FIG. 3 is a flowchart of another information recommendation method according to an embodiment of the present disclosure;

FIG. 4 is a flowchart of yet another information recommendation method according to an embodiment of the present disclosure;

FIG. 5 is a schematic diagram of relationships in a circle of friends according to an embodiment of the present disclosure;

FIG. 6 is a block diagram of an information recommendation apparatus according to an embodiment of the present disclosure;

FIG. 7 is a block diagram of an influence degree determining module according to an embodiment of the present disclosure;

FIG. 8 is a block diagram of a linear calculation unit according to an embodiment of the present disclosure;

FIG. 9 is a block diagram of another information recommendation apparatus according to an embodiment of the present disclosure;

FIG. 10 is a block diagram of a target influence degree determining module according to an embodiment of the present disclosure;

FIG. 11 is another block diagram of a target influence degree determining module according to an embodiment of the present disclosure; and

FIG. 12 is a hardware block diagram of yet another information recommendation apparatus according to an embodiment of the present disclosure.

### DETAILED DESCRIPTION OF THE EMBODIMENTS

After a friend of a user interacts with recommended information, a probability that the user interacts with the recommended information is increased. In a case that a certain type of interaction (such as making comments or giving the thumbs-up) is made by the friend of the user with the recommended information, a probability that the same type of interaction is made by the user with the recommended information is increased.

On the basis of the above, with an information recommendation method according to an embodiment of the present disclosure, the recommended information is pushed based on the rule that an interaction to be made by the target user with the recommended information is influenced by the interaction previously made by the friend of the target user with the recommended information, thereby increasing accuracy of determined probability that the user interacts with the recommended information, and improving effectiveness of pushing the recommended information.

The technical solutions according to embodiments of the present disclosure will be described clearly and completely in conjunction with the drawings in embodiments of the present closure. Apparently, the described embodiments are only a part of the embodiments according to the present disclosure, rather than all the embodiments. Any other embodiments obtained by those skilled in the art based on the embodiments of the present disclosure fall within the scope of protection of the present disclosure.

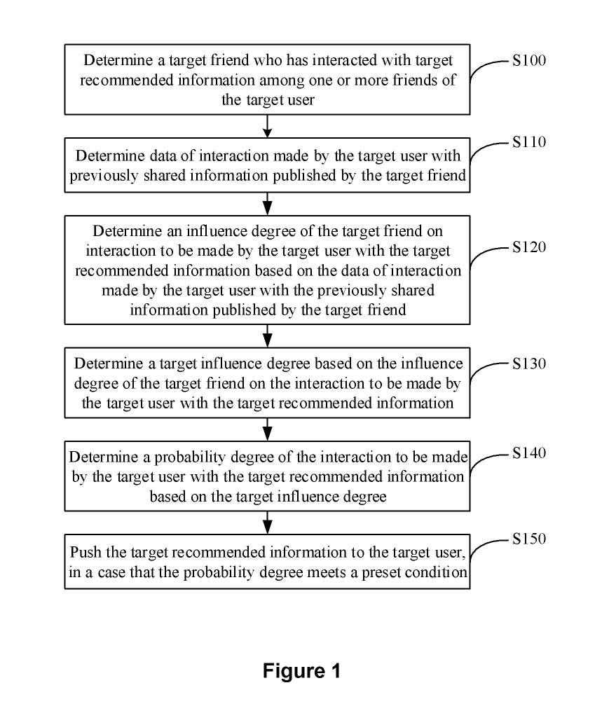

FIG. 1 is a flowchart of an information recommendation method according to an embodiment of the present disclosure. The method may be applied to a server, where the server may collect user behavioral data of a social application, analyze and process the data, and push the recommended information.

Referring to FIG. 1, the information recommendation method provided according to an embodiment of the present disclosure may include step S100 to step S150.

In step S100, a target friend who has interacted with target recommended information among one or more friends of a target user is determined.

The target recommended information is information to be recommended to the target user. In an embodiment of the present disclosure, the target recommended information has been pushed to at least one friend of the target user, while has not been pushed to the target user. A target friend among the at least one friend has interacted (such as making a comment or giving the thumbs-up) with the target recommended information.

In step S110, data of interaction made by the target user with previously shared information published by the target friend is determined.

The social application provides a function of sharing information among friends, with which a user can share information, such as an article and music, with the friend of the user, and the friend can make interaction, such as making comments, forwarding, or giving the thumbs-up, with the information shared by the user. Similarly, the user can also interact with information shared by the friend of the user.

In an embodiment of the present disclosure, for a target friend, interaction made by the target user with the previously shared information published by the target friend in a preset time period may be analyzed to obtain the interaction data.

In an embodiment of the present disclosure, for each determined target friend, the number of interactions of each preset type made by the user with the previously shared information published by the target friend in a preset time period may be analyzed. The interactions of a preset type may refers to an interactive operation performed on the shared information by the user such as giving the thumbs-up and making a comment, which may be determined based on actual usage requirements. Therefore, according to an embodiment of the present disclosure, the number of interactions of a preset type can serve as an eigenvector, and each of the eigenvectors is collected to obtain an eigenvector set, which serves as the data of interaction made by the target user with the previously shared information published by the target friend.

In an embodiment of the present disclosure, for each determined target friend, the number of interactions of each preset type made by the user with the previously shared information published by the target friend in a preset time period, may be analyzed to obtain the integrated number of interactions by integrating the number of interactions of each preset types. The integrated number of interactions serves as the data of interaction made by the target user with the previously shared information published by the target friend.

In step 120, an influence degree of the target friend on interaction to be made by the target user with the target recommended information is determined based on the data of interaction made by the target user with the previously shared information published by the target friend.

On the basis of a discovery that the interaction made by the friend of the user with the recommended information leads to a high probability that the user interacts with the recommended information, according to an embodiment of the present disclosure, the rule that an interaction to be made by the user with the recommended information is influenced by the interaction previously made by the friend of the user with the recommended information, may be quantified as the influence degree of the target friend on the interaction to be made by the target user with the target recommended information, and the rule of interaction made by the user with the shared information published by the friend is quantified as the data of interaction made by the target user with the previously shared information published by the target user.

Then, based on a pre-analyzed functional relationship between a influence degree of the friend on the interaction to be made by the user with the recommended information, and data of interaction made by the user with the previously shared information published by the friend, the influence degree of the target friend on the interaction to be made by the target user with the target recommended information is determined for each of the target users, based on the interaction data and the pre-analyzed functional relationship.

In an embodiment of the present disclosure, by analyzing history behavior data, it is found that the rule of interaction to be made by the target user with the shared information published by the friend, has an extremely high similarity with the rule of interaction made by the target user with the recommended information after being influenced by the interaction made by the friend of the target user interacts with the recommended information, which shows a linear relationship. That is, the rule of interaction made by the target user with the recommended information after being influenced by the interaction already made by the friend of the target user with the recommended information has a linear relationship with the rule of interaction to be made by the target user with the shared information published by the friend. Therefore, for each of the target friends, after obtaining the data of interaction made by the target user with the previously shared information published by the target friend, according to an embodiment of the present disclosure, the influence degree of the target friend on the interaction to be made by the target user with the target recommended information can be calculated based on the linear relationship.

The linear relationship, which is between the rule of interaction made by the user with the recommended information after being influenced by the interaction made by the friend of the user with the recommended information and the rule of interaction to be made by the user with the shared information published by the friend, is only an example of the functional relationship mentioned above. In practice, the relationship may also be other functional relationships than the linear relationship.

In step S130, a target influence degree is determined based on the influence degree of the target friend on the interaction to be made by the target user with the target recommended information.

The target influence degree is an overall influence degree of at least one target friend on the interaction to be made by the target user with the target recommended information.

In an embodiment of the present disclosure, the influence degree of each of the target friends on the interaction to be made by the target user with the target recommended information may be summed up, to obtain the target influence degree.

Time when each of the target friends interacts with the target recommended information is different from one another, that is, some interactions happen earlier, while other interactions happen later. The different time of the interactions made by the target friend with the target recommended information have different influence degrees on the interaction to be made by the target user with the target recommended information. Therefore, according to an embodiment of the present disclosure, the influence degree of interactions happened earlier may be adjusted with a time attenuation factor, so that the influence degree of each of the target friends on the interaction to be made by the target user with the target recommended information matches the timing of the interaction, thereby improving the accuracy of the target influence degree determined by summing up the influence degree of each of the target friends on the interaction to be made by the target user with the target recommended information.

In step S140, a probability degree of the interaction to be made by the target user with the target recommended information is determined based on the target influence degree.

In an embodiment of the present disclosure, the target influence degree may be combined with a determined interest level of the target user in the target recommended information, to determine the probability degree of the interaction to be made by the target user with the target recommended information. In an embodiment of the present disclosure, the target influence degree may also solely serve as the probability degree of the interaction to be made by the target user with the target recommended information.

In step S150, the target recommended information is pushed to the target user, in a case that the probability degree meets a preset condition.

In an embodiment of the present disclosure, the preset condition may be determined according to actual usage demands.

It can be seen that, based on a discovery that the rule of interaction made by the user with the shared information published by a friend is relevant to an influence of the friend on interaction to be made by the user with recommended information, in an embodiment of the present disclosure the data of interaction made by the target user with the previously shared information published by the target friend is determined, for the target friend among the one or more friends of the target user, who has interacted with the target recommended information. Then the influence degree of the target friend on the interaction to be made by the target user with the target recommended information is determined. Then the influence degree of each of the target friends on the interaction to be made by the target user with the target recommended information is integrated to determine the target influence degree of the friend who has interacted with the target recommended information, on the interaction to be made by the target user with the target recommended information is determined. The probability degree of the interaction to be made by the target user with the target recommended information is determined based on the target influence degree, for pushing the target recommended information. Because the influence degree of the friend on the interaction to be made by the target user with the target recommended information is referred to in determining the probability degree of the interaction to be made by the target user with the target recommended information in an embodiment of the present disclosure, accuracy of the determined probability that the user interacts with the recommended information is increased, so as to improve the effectiveness of pushing the recommended information.

In an embodiment of the present disclosure, the data of interaction made by the target user with the previously shared information published by the target friend has the linear relationship with the influence degree of the target friend on the interaction to be made by the target user with the target recommended information. Therefore, according to an embodiment of the present disclosure, the influence degree of each of the target friends on the interaction to be made by the target user with the target recommended information may be determined based on the linear relationship and data of interaction made by the target user with the previously shared information published by the target friends.

The linear relationship is mainly expressed by a monadic linear regression equation. According to an embodiment of the present disclosure, the data of interaction made by the target user with the previously shared information published by the target friend, and the influence degree of the target friend on the interaction to be made by the target user with the target recommended information, serve as variables of the monadic linear regression equation. Then equation is solved by calculating a coefficient and a constant with the monadic linear regression equation. By the equation, an influence degree corresponding to interaction data can be calculated.

According to an embodiment of the present disclosure, the influence degree of each of the target friends on the interaction to be made by the target user with the target recommended information can be calculated by the following equation.

Based on an equation cᵢⱼ=w·nᵢⱼ+b, the influence degree of a target friend on the interaction to be made by the target user with the target recommended information is determined.

Denoting the target friend as j and the target user as i in the equation, cᵢⱼ is the influence degree of the target friend j on the interaction to be made by the target user i with the recommended information, nᵢⱼ is the number of interactions made by the target user i with the previously shared information published by the target friend j, w is a preset interaction weight, and b is a preset constant.

To solve the above equation, it may be required to determine the preset interaction weight w and the preset constant b in an embodiment of the present disclosure. Then after determining the data nᵢⱼ of interaction made by the target user with the previously shared information published by the target friend, the corresponding cᵢⱼ can be obtained.

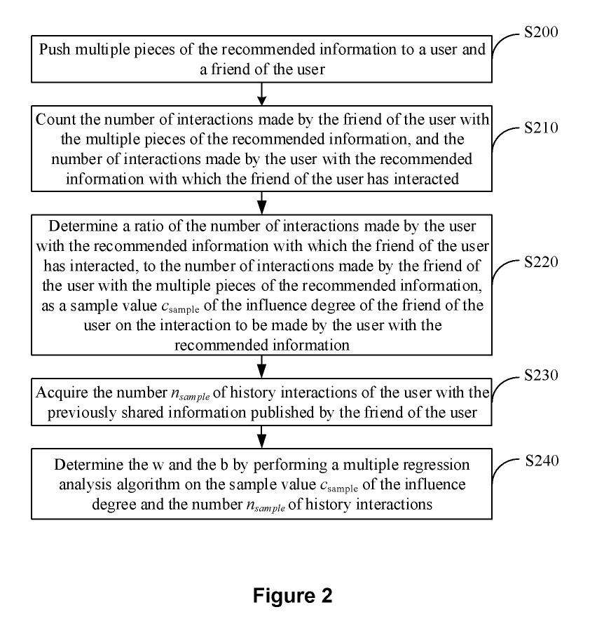

FIG. 2 shows a flowchart of a method for determining the interaction weigh w and the preset constant b. Referring to FIG. 2, the method may include step S200 to step S240.

In step S200, multiple pieces of the recommended information are pushed to a user and a friend of the user.

The user and the friend of the user in the step S200 may be a user sampled for determining w and b, and the friend corresponding to the sampled user.

In step S210, the number of interactions made by the friend of the user with the multiple pieces of the recommended information is counted, and the number of interactions made by the user with the recommended information with which the friend of the user has interacted is counted.

For example, 10 pieces of recommended information are pushed to the user and the friend of the user. The friend of the user interacts with all the 10 pieces of recommended information. After the friend of the user interacts with the 10 pieces of the recommended information, the user interacts with only 3 of the 10 pieces of information. Then it can be determined that the number of interactions made by the friend of the user with the multiple pieces of the recommended information is 10, and the number of interactions made by the user with the recommended information with which the friend of the user has interacted is 3.

The number of interactions made by the user with the recommended information with which the friend of the user has interacted is the number of interactions made by the user with the recommended information under the condition that the friend of the user has interacted with the recommended information. In a case that the friend of the user did not interact with the recommended information before the user interacts with the recommended information, the interaction made by the user with the recommended information which has not been interacted with the friend of the user, should not be counted into the number of interactions made by the user with the recommended information with which the friend of the user has interacted.

In step 220, a ratio of the number of interactions made by the user with the recommended information with which the friend of the user has interacted, to the number of interactions made by the friend of the user with the multiple pieces of the recommended information, is determined as a sample value cₛₐₘₚₗₑ of the influence degree of the friend of the user on the interaction to be made by the user with the recommended information.

For example, in a case that the number of interactions made by the friend of the user with the multiple pieces of the recommended information is 10 and the number of interactions made by the user with the recommended information with which the friend of the user has interacted is 3, the sample value cₛₐₘₚₗₑ of the influence degree of the friend of the user on the interaction to be made by the user with the recommended information is determined to be 3/10.

In an embodiment of the present disclosure, the user may have multiple friends. The number of interactions made by a friend of the user with the multiple pieces of the recommended information, and the number of interactions made by the user with the recommended information with which the friend of the user has interacted, may be determined for each of the friends of the user, and then the influence degree corresponding to each of the friends of the user is calculated as the sample value Cₛₐₘₚₗₑ of the influence degree.

Apparently, in an embodiment of the present disclosure, the user may only have one friend.

In step 230, the number nₛₐₘₚₗₑ of history interactions made by the user with the previously shared information published by the friend of the user is acquired.

The step 230 may be performed as the step S110 shown in FIG. 1.

In step S240, the w and the b are determined by performing a multiple regression analysis algorithm on the sample value cₛₐₘₚₗₑ of the influence degree and the number of the history interactions nₛₐₘₚₗₑ.

According to an embodiment of the present disclosure, the monadic linear regression equation may be established. Using the sample value Cₛₐₘₚₗₑ of the influence degree and the number of the history interactions nₛₐₘₚₗₑ as variables, w and b are calculated with the multiple regression analysis algorithm.

After calculating w and b, the influence degree cᵢⱼ of the target friend on the interaction to be made by the target user with the target recommended information may be calculated on the basis of the data n₁ of interaction made by the target user with the previously shared information published by the target friend.

In this embodiment of the present disclosure, the number nᵢⱼ of interactions made by the target user i with the previously shared information published by the target friend j may be an integrated number of interactions obtained by integrating the number of interactions of each preset type made by the target user i with the previously shared information published by the target friend j, and the corresponding w may be an integrated interaction weight. Correspondingly, the number nₛₐₘₚₗₑ of history interactions may be an integrated number of interactions in the calculation shown in FIG. 2.

According to an embodiment of the present disclosure, the type of interaction made by the target user with the previously shared information published by the target friend may be preset. Accordingly, the number of interactions of each preset type made by the target user with the previously shared information published by the target friend is represented as an eigenvector. Each preset type corresponds to a type of interactions. The eigenvectors are collected to acquire an eigenvector set, which serves as the data of interaction made by the target user with the previously shared information published by the target friend.

For example, the preset interaction type includes making comments or giving the thumbs-up by the target user for the previously shared information published by the target friend, and a chatting frequency (such as an average number of chatting in each day) between the target user and the target friend. According to an embodiment of the present disclosure, for each of the target friends, the number of times of making comments and the number of times of giving the thumbs-up by the target user for the previously shared information published by the target friend, and the chatting frequency between the target user and the target friend may be obtained as eigenvectors, which are collected to acquire the eigenvector set nᵢⱼ.

The nᵢⱼ may be expressed as nᵢⱼ=(hᵢⱼ,kᵢⱼ,mᵢⱼ), where hᵢⱼ is the number of times of giving the thumbs-up by the target user i for the previously shared information published by the target friend j, kᵢⱼ is the number of times of making comments by the target user i on the previously shared information published by the target friend j, and mᵢⱼ is the chatting frequency between the target user i and the target friend j.

Accordingly, w is expressed as w=(wₕ,wₖ,wₘ), where wₕ is a weight of giving the thumbs-up, wₖ is a weight of making comments, and wₘ is a weight of chatting frequency.

Accordingly, in the method shown in FIG. 2, the number nₛₐₘₚₗₑ of history interactions may be the eigenvector set of the numbers of preset types of interactions, and w may be a set of weights for all the preset types.

The giving the thumbs-up and the making comments by the target user for the previously shared information published by the target friend, and the chatting frequency between the target user and the target friend as shown above, are only examples of the preset interaction type. The specific form of the preset interaction type may be determined based on usage, and apparently, there may be only one preset interaction type.

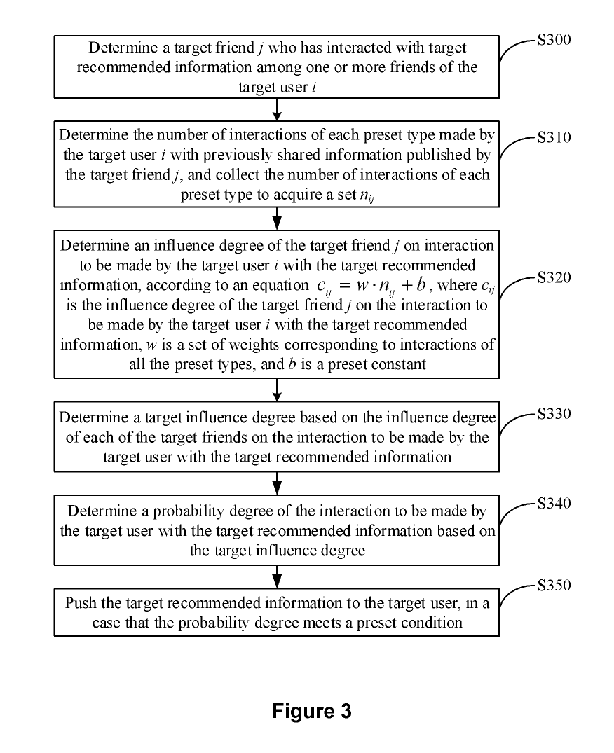

FIG. 3 shows another flowchart of an information recommendation method according to an embodiment of the present disclosure, and the method may be applied to a server or other devices. Referring to FIG. 3, the method may include step S300 to step S350.

In step S300, at least one target friend j who has interacted with target recommended information among one or more friends of a target user i is determined.

In step S310, the number of interactions of each preset type made by the target user i with the previously shared information published by the target friend j is determined, and the numbers of interactions of each preset type are collected to acquire a set nᵢⱼ.

In step S320, an influence degree of the target friend j on interaction to be made by the target user i with the target recommended information is determined according to an equation cᵢⱼ=w·nᵢⱼ+b, so as to acquire the influence degree of each of the target friends on the interaction to be made by the target user with the target recommended information, where cᵢⱼ is the influence degree of the target friend j on the interaction to be made by the target user i with the target recommended information, w is a preset of weights of all the preset types, and b is a preset constant.

In step S330, a target influence degree is determined based on the influence degree of each of the target friends on the interaction to be made by the target user with the target recommended information.

In step S340, a probability degree of the interaction to be made by the target user with the target recommended information is determined based on the target influence degree.

In step S350, the target recommended information is pushed to the target user, in a case that the probability degree meets a preset condition.

In this embodiment of the present disclosure, after the influence degree of each of the target friends on the interaction to be made by the target user with the target recommended information is obtained, the influence degree of each of the target friends on the interaction to be made by the target user with the target recommended information is integrated to acquire the target influence degree.

The target influence degree may be determined by determining the target influence degree according to an equation

$$InfluScore = {\sum }_{j ∈ N} {c}_{ij} ,$$

where InfluScore is the target influence degree, and N is a set of at least one target friend who has interacted with the target recommended information among the one or more friends of the target user. That is, the influence degrees of the target friends on the interaction to be made by the target user with the target recommended information are summed up to acquire the target influence degree.

Alternatively, the target influence degree may be determined by determining the target influence degree according to an equation InfluScore=newcᵢⱼ+f·Incluscore_old, where InfluScore is the target influence degree, newcᵢⱼ is an influence degree of the target friend, who made the latest interaction with the target recommended information, on the interaction to be made by the target user with the target recommended information, f is a current time attenuation factor, and InfluScore_old is a sum of the influence degrees of other target friends. A calculation method for InfluScore_old is the same as that for InfluScore, and is not further described here.

The timing of making interactions by the target friends with the target recommended information is different from one another, and different timing of the interactions leads to a difference in the influence degrees of the target friends on the interaction to be made by the target user with the target recommended information. Therefore, when a new target friend interacts with the target recommended information, the influence degree generated by other friend previously should be attenuated. That is, InfluScore=newcᵢⱼ+f·Incluscore_old. Apparently, InfluScore_old is also attenuated with interaction time.

For example, the target friends A1, A2 and A3 are friends influencing the target user, and the target friends A1, A2 and A3 interacts with the target recommended information in sequence. When A2 interacts with the target recommended information, the target influence degree is calculated as the influence degree of A2+f2*the influence degree of A1. When A3 interacts with the target recommended information, the target influence degree is calculated as the influence degree of A3+f3*(the influence degree of A2+f2*the influence degree of A1).

The time attenuation factor f may be a reciprocal of the current time, for example, f2 may be a reciprocal of the time when A2 interacts with the target recommended information, which is also true for f3.

After determining the target influence degree, according to an embodiment of the present disclosure, the probability degree of the interaction to be made by the target user with the target recommended information may be determined by combing the target influence degree and an interest level of the target user in the target recommended information which is determined by conventional technology.

According to an embodiment of the present disclosure, the interest level of the target user in the target recommended information may be determined, and then the probability degree of the interaction to be made by the target user with the target recommended information is determined based on the interest level and the target influence degree.

In an embodiment of the present disclosure, the interest level of the target user in the target recommended information may be determined by any conventional technology.

The interest level and the target influence degree may be combined by taking the interest level and the target influence degree as inputs to a model, such as a logistic regression model, to calculate an output result (that is, the probability degree of the interaction to be made by the target user with the target recommended information).

In an embodiment of the present disclosure, the interest level and the target influence degree may be summed up.

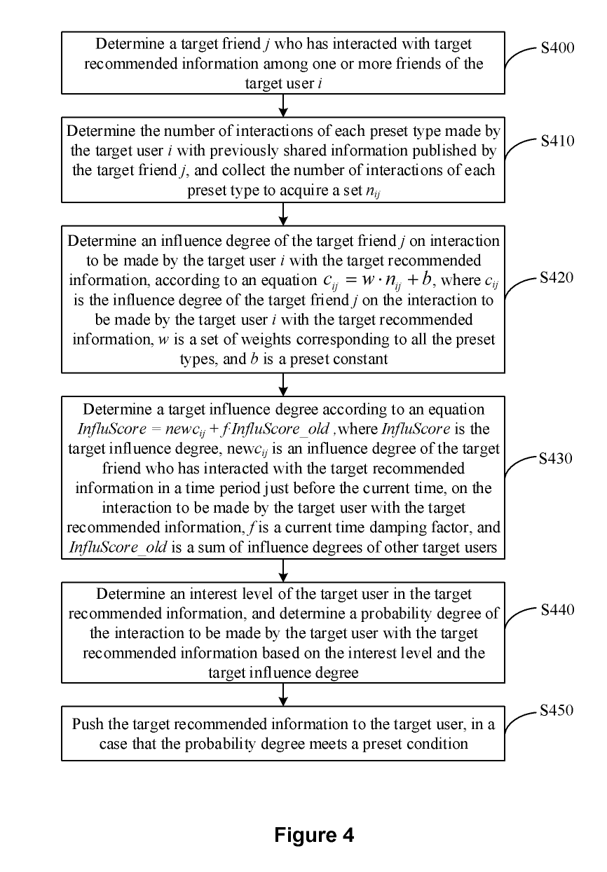

FIG. 4 shows yet another flowchart of an information recommendation method according to an embodiment of the present disclosure, and the method may be applied to a server or other devices. Referring to FIG. 4, the method may include step S400 to step S450.

In step S400, at least one target friend j who has interacted with target recommended information among one or more friends of a target user i is determined.

In step S410, the number of interactions of each preset type made by the target user i with previously shared information published by the target friend j is determined, and the numbers of interactions of each preset type are collected to acquire a set n₁.

In step S420, an influence degree of the target friend j on interaction to be made by the target user i with the target recommended information is determined according to an equation cᵢⱼ=w·nᵢⱼ+b, so as to acquire the influence degree of each of the target friends on the interaction to be made by the target user with the target recommended information, where cᵢⱼ is the influence degree of the target friend j on the interaction to be made by the target user i with the target recommended information, w is a set of weights of all the preset types, and b is a preset constant.

In step S430, a target influence degree is determined, according to an equation InfluScore=newcᵢⱼ+f·Incluscore_old, where InfluScore is the target influence degree, newcᵢⱼ is an influence degree of the target friend who made the latest interaction with the target recommended information, on the interaction to be made by the target user with the target recommended information, f is a current time attenuation factor, InfluScore_old is a sum of the influence degrees of other target users than newcᵢⱼ. A calculation method for InfluScore_old is the same as that for InfluScore, which is not described here.

In step S440, an interest level of the target user in the target recommended information is determined, and a probability degree of the interaction to be made by the target user with the target recommended information is determined based on the interest level and the target influence degree.

In step S450, the target recommended information is pushed to the target user, in a case that the probability degree meets a preset condition.

In an embodiment of the present disclosure, after the probability degree of the interaction to be made by the target user with the target recommended information is obtained, it may be determined whether the probability degree is larger than a preset probability degree. In a case that the probability degree is larger than the preset probability degree, it is determined that the probability meets the preset condition, and then the target recommended information is pushed to the target user.

The target recommended information may be one of multiple pieces of candidate recommended information. According to an embodiment of the present disclosure, the probability degree of the interaction to be made by the target user with each of the candidate recommended information may be determined in the above manner of determining the probability degree, thereby ranking the candidate recommended information based on their probability degree after determining the probability degree of the interaction to be made by the target user with each of the candidate recommended information. In a case that a rank of the target recommended information meets a preset rank condition, it is determined that the probability degree meets the preset condition, and then the target recommended information is pushed to the target user. In a case that a rank of the target recommended information is in a preset range of rank, it can be determined that the probability degree meets the preset condition, and the target recommended information can be pushed to the target user.

An application of the information recommendation method according to an embodiment of the present disclosure is to push advertisements, which is taken as an example to explain an application of the information recommendation method according to an embodiment of the present disclosure.

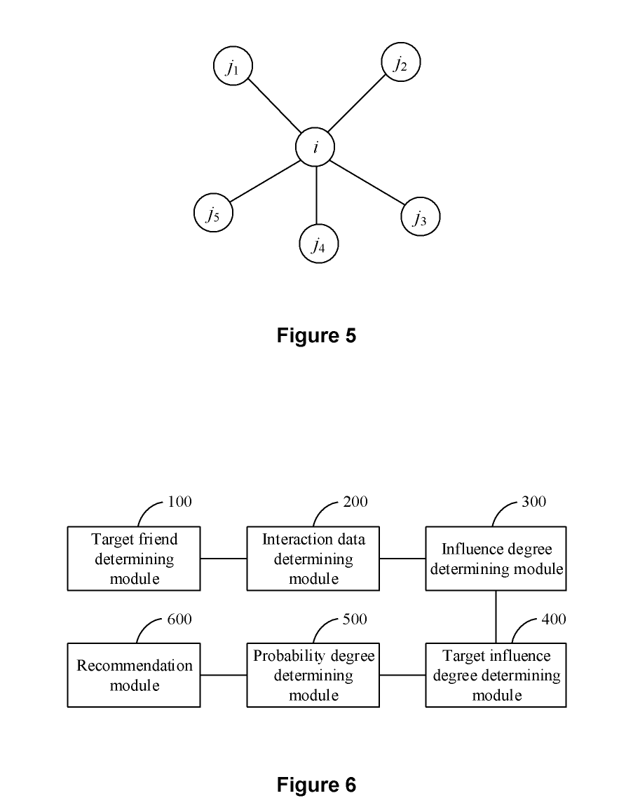

FIG. 5 shows relationships in a circle of friends, where the circle of friends is a friend social circle provided by a social application. Referring to FIG. 5, it is assumed that the friends of the target user i are j₁, j₂, j₃, j₄ and j₅, and j₁, j₂ and j₃ interact with the advertisement respectively at time t₁, t₂ and t₃, and t₁<t₂<t₃; j₄ does not interact with the advertisement although the advertisement can be viewed by j₄, and j₅ cannot view the advertisement. Therefore, only the friends j₁, j₂ and j₃ influence the user i, and it is determined that the target friends who have interacted with the advertisement among the one or more friends of the target user i are j₁, j₂ and j₃.

For the friend j₁, the number of interactions of each preset type made by the user i with the previously shared information published by the friend j₁ in a preset time period may be determined, and the set of the numbers of interactions of all the preset types serves as the number nᵢⱼ₁ of interactions made by the user i with the previously shared information published by the friend j₁. The preset type may include giving the thumbs-up or making comments by the user i for the previously shared information published by the friend j₁, and the chatting frequency between the user i and the friend j₁, which apparently may also be customized otherwise.

For the friend j₂, the number of interactions of each preset type made by the user i with the previously shared information published by the friend j₂ in a preset time period can be determined, and the set of the numbers of interactions of all the preset types serves as the number nᵢⱼ₂ of interactions made by the user i with the previously shared information published by the friend j₂.

For the friend j₃, the number of interactions of each preset type made by the user i with the previously shared information published by the friend j₃ in a preset time period can be determined, and the set of the numbers of interactions of all the preset types serves as the number nᵢⱼ₃ of interactions made by the user i with the previously shared information published by the friend j₃.

For the friend the influence degree of the friend j₁ on the interaction to be made by the user i with the advertisement is determined according to an equation cᵢⱼ=w·nᵢⱼ₁+b. For the friend j₂, the influence degree of the friend j₂ on the interaction to be made by the user i with the advertisement is determined according to an equation cᵢⱼ=w·nᵢⱼ₂+b. For the friend j₃, the influence degree of the friend j₃ on the interaction to be made by the user i with the advertisement is determined according to an equation cᵢⱼ=w·nᵢⱼ₃+b; where w is a set of pre-calculated weights for all the preset types, and b is a pre-calculated constant.

After cᵢⱼ₁, cᵢⱼ₂ and cᵢⱼ₃ are obtained, because the timing of the interactions between the friends j₁, j₂ and j₃ and the advertisement is t₁, t₂ and t₃ respectively, and t₁<t₂<t₃, by taking attenuation of the influence degree with time into account, the target influence degree may be calculated as: ^{c}^{ᵢⱼ}f3+f3(^{c}^{ᵢⱼ₂}+f2^{c}^{ᵢⱼ₁}, where f2 corresponds to t₂ and may be a reciprocal of t₂, and f3 corresponds to t₃ and may be a reciprocal of t₃.

After the target influence degree is obtained, the target influence degree and the interest level of the user i in the advertisement may be combined to determine the probability degree of the interaction to be made by the user i with the advertisement, so as to determine the rank of the advertisement among candidate advertisements on the basis of the probability degree of the interaction to be made by the user i with the advertisement. In a case that the determined rank is in a preset range of rank, the advertisement is pushed to the user i. After the advertisement is pushed to the user i, because the probability that the user i interacts with the advertisement is high, an interaction effect of pushing the advertisement is increased, so that the effectiveness of pushing the advertisement is improved.

With an information recommendation method according to an embodiment of the present disclosure, the accuracy of determined probability degree of the interaction to be made by the user with the recommended information is increased, so that the effectiveness of pushing the recommended information is improved.

Hereinafter an information recommendation apparatus according to an embodiment of the present disclosure is described. The information recommendation apparatus described hereinafter and the information recommendation method may be referred to each other.

FIG. 6 is a block diagram of an information recommendation apparatus according to an embodiment of the present disclosure, and the apparatus may be applied to a server. Referring to FIG. 6, and the information recommendation apparatus may include a target friend determining module 100, an interaction data determining module 200, an influence degree determining module 300, a target influence degree determining module 400, a probability degree determining module 500, and a recommendation module 600.

The target friend determining module 100 is configured to determine a target friend who has interacted with target recommended information among one or more friends of a target user.

The interaction data determining module 200 is configured to determine data of interaction made by the target user with previously shared information published by the target friend.

The influence degree determining module 300 is configured to determine an influence degree of the target friend on interaction to be made by the target user with the target recommended information based on the data of interaction made by the target user with the previously shared information published by the target friend.

The target influence degree determining module 400 is configured to determine a target influence degree based on the influence degree of the target friend on the interaction to be made by the target user with the target recommended information.

The probability degree determining module 500 is configured to determine a probability degree of the interaction to be made by the target user with the target recommended information based on the target influence degree.

The recommendation module 600 is configured to push the target recommended information to the target user, in a case that the probability degree meets a preset condition.

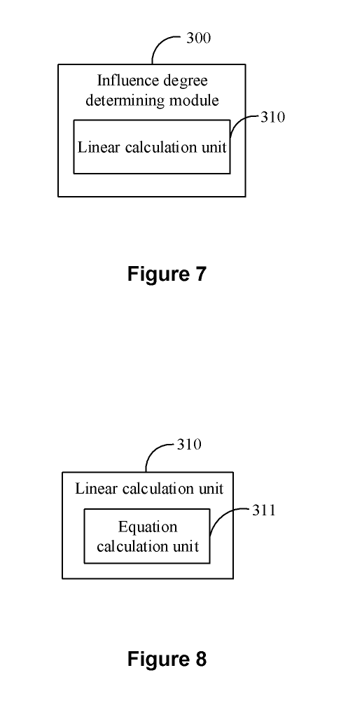

The data of interaction made by the target user with the previously shared information published by the target friend is in a linear relationship with the influence degree of the target friend on the interaction to be made by the target user with the target recommended information. FIG. 7 shows an optional structure of the influence degree determining module 300. Referring to FIG. 7, the influence degree determining module 300 may include a linear calculation unit 310.

The linear calculation unit 310 is configured to determine the influence degree of the target friend on the interaction to be made by the target user with the target recommended information based on the linear relationship and the data of interaction made by the target user with the previously shared information published by the target friends.

FIG. 8 shows an optional structure of the linear calculation unit 310. Referring to FIG. 8, the linear calculation unit 310 may include an equation calculation unit 311.

The equation calculation unit 311 is configured to determine an influence degree of one target friend on the interaction to be made by the target user with the target recommended information, according to an equation cᵢⱼ=w·nᵢⱼ+b, where cᵢⱼ is the influence degree of the target friend j on the interaction to be made by the target user i with the target recommended information, nᵢⱼ is the number of interactions made by the target user i with the previously shared information published by the target friend j, w is a preset interaction weight, and b is a preset constant.

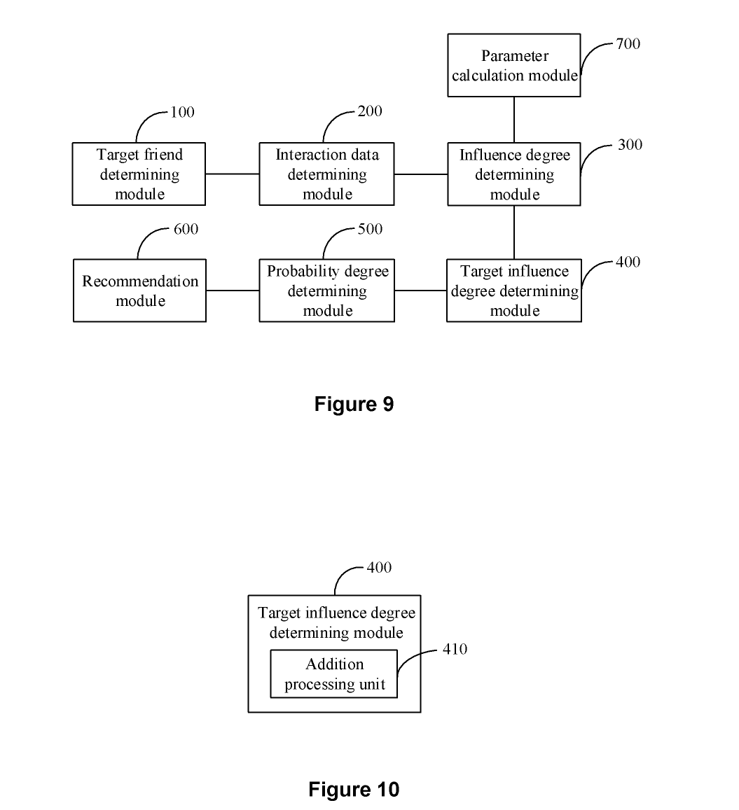

FIG. 9 shows another block diagram of an information recommendation apparatus according to an embodiment of the present disclosure. As shown in conjunction with FIG. 6, FIG. 8 and FIG. 9, the apparatus may further include a parameter calculation module 700.

The parameter calculation module 700 is configured to push multiple pieces of the recommended information to a user and a friend of the user; count the number of interactions made by the friend of the user with the multiple pieces of the recommended information, and the number of interactions made by the user with the recommended information with which the friend of the user has interacted; determine a ratio of the number of interactions made by the user with the recommended information with which the friend of the user has interacted, to the number of interactions made by the friend of the user with the multiple pieces of the recommended information, as a sample value Cₛₐₘₚₗₑ of the influence degree of the friend of the user on the interaction to be made by the user with the recommended information; acquire the number nₛₐₘₚₗₑ of history interactions made by the user with the previously shared information published by the friend of the user; and determine the w and the b by performing a multiple regression analysis algorithm on the sample value Cₛₐₘₚₗₑ of the influence degree and the number nₛₐₘₚₗₑ of history interactions.

The nᵢⱼ includes a set of the numbers of interactions of all the preset types made by the target user i with the previously shared information published by the target friend j. Accordingly, the w includes a set of the weights of all the preset types.

FIG. 10 shows an optional structure of the target influence degree determining module 400. Referring to FIG. 10, the target influence degree determining module 400 may include an addition processing unit 410.

The addition processing unit 410 is configured to determine the target influence degree according to an equation

$$InfluScore = {\sum }_{j ∈ N} {c}_{ij} ,$$

where InfluScore is the target influence degree, and N is a set of at least one target friend who has interacted with the target recommended information among the one or more friends of the target user.

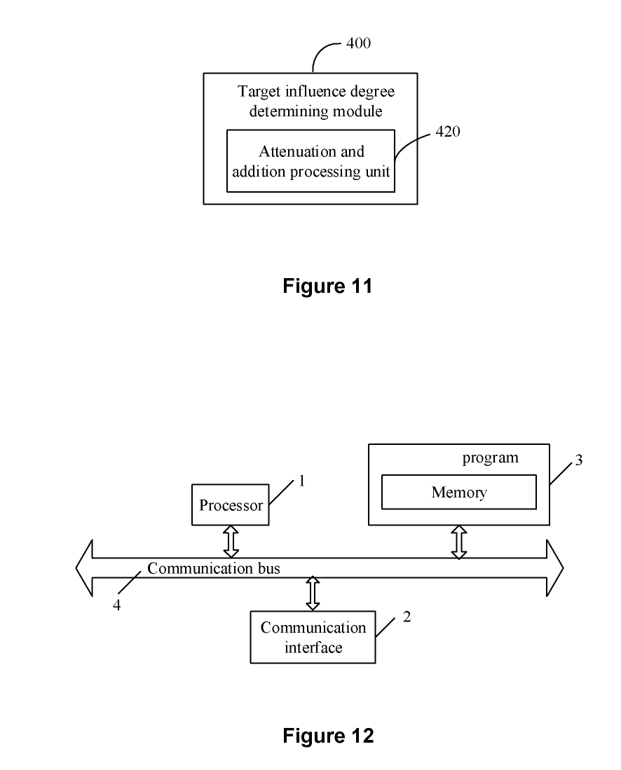

FIG. 11 shows another optional structure of the influence degree determining module 400 according to an embodiment of the present disclosure. Referring to FIG. 11, the target influence degree determining module 400 may include an attenuation and addition processing unit 420.

The attenuation and addition processing unit 420 is configured to determine the target influence degree according to an equation InfluScore=newcᵢⱼ+f·Incluscore_old, where InfluScore is the target influence degree, newcᵢⱼ is an influence degree of the target friend, who has interacted with the target recommended information in a time period just before the current time, on the interaction to be made by the target user with the target recommended information, f is a current time attenuation factor, InfluScore_old is a sum of the influence degrees of other target users than newcᵢⱼ, and a calculation method for InfluScore_old is the same as that for InfluScore, which is not described here.

The probability degree determining module 500 may be configured to determine an interest level of the target user in the target recommended information, and determine a probability degree of the interaction to be made by the target user with the target recommended information based on the interest level and the target influence degree.

In an aspect, the recommendation module 600 may be configured to determine that the probability degree meets the preset condition and push the target recommended information to the target user, in a case that the probability degree is greater than a preset probability degree.

In another aspect, the recommendation module 600 may be configured to rank candidate recommended information including the target recommended information according to the probability degree of each candidate recommended information, after determining the probability degree of interaction to be made by the target user with each candidate recommended information, and determine that the probability degree meets the preset condition and push the target recommended information to the target user, in a case that a rank of the target recommended information meets a preset rank condition.

With the information recommendation apparatus according to an embodiment of the present disclosure, the accuracy of determined probability degree of the interaction to be made by the user with the recommended information is increased, so that the effectiveness of pushing the recommended information is improved.

Optionally, FIG. 12 shows a hardware block diagram of another information recommendation apparatus according to an embodiment of the present disclosure. Referring to FIG. 12, the apparatus may include: a processor 1, a communication interface 2, a memory 3, and a communication bus 4.

The processor 1, the communication interface 2, and the memory 3 communicate with each other via the communication bus 4.

Optionally, the communication interface 2 may be an interface of a communications module, such as an interface of a GSM module.

The processor 1 is configured to execute a program.

The memory 3 is configured to store the program.

The program may include a program code, where the program code includes an operation instruction of computer.

The processor 1 may be a central processor unit CPU, an application specific integrated circuit ASIC (Application Specific Integrated Circuit), or one or more integrated circuits configured to implement embodiments of the present disclosure.

The memory 3 may include a high speed RAM memory, and may further include a non-volatile memory (non-volatile memory), such as at least one magnetic disk memory.

The program may be specifically configured to:

determine a target friend who has interacted with target recommended information among one or more friends of a target user;

determine data of interaction made by the target user with previously shared information published by the target friend;

determine an influence degree of the target friend on interaction to be made by the target user with the target recommended information based on the data of interaction made by the target user with the previously shared information published by the target friend;

determine a target influence degree based on the influence degree of the target friend on the interaction to be made by the target user with the target recommended information;

determine a probability degree of the interaction to be made by the target user with the target recommended information based on the target influence degree; and

push the target recommended information to the target user, in a case that the probability degree meets a preset condition.

A server is further provided to an embodiment of the present disclosure, where the server may include the information recommendation apparatus described above.

The embodiments of the present disclosure are described in a progressive manner, and each embodiment places emphasis on the difference from other embodiments. Therefore, the embodiments may be referred to one another for the same or similar parts. Since the apparatus embodiments correspond to the method embodiment, the description of the apparatus embodiments is simple. For the relevant portions, one may refer to the description of the method parts.

As further be appreciated by those skilled in the art, the units and algorithmic steps in the examples described according to the embodiments disclosed herein can be implemented in forms of an electronic hardware, computer software or the combination thereof. To illustrate the interchangeability of the hardware and the software clearly, the components and the steps in the examples are described generally according to functions in the above description. Whether hardware or software is used to implement the functions depending on a specific application and design constraints for the technical solution. For each specific application, different methods may be used by those skilled in the art to implement the described function, and such implementation should not be considered as departing from the scope of the disclosure.

The steps of the method or algorithm described according to the embodiments disclosed herein may be implemented in forms of hardware, a software module executed by a processor or the combination thereof. The software module may be stored in a Random Access Memory (RAM), a memory, a Read-Only Memory (ROM), an electrically programmable ROM, an electrically erasable programmable ROM, a register, a hardware disk, a movable magnetic disk, CD-ROM or any other forms of storage medium well known in the art.

The above description of the embodiments disclosed herein enables those skilled in the art to implement or use the present disclosure. Numerous modifications to the embodiments will be apparent to those skilled in the art, and the general principle herein can be implemented in other embodiments without deviation from the spirit or scope of the present disclosure. Therefore, the present disclosure is not limited to the embodiments described herein, but in accordance with the widest scope consistent with the principle and novel features disclosed herein.

1. An information recommendation method, comprising:
determining a target friend who has interacted with target recommended information among one or more friends of a target user;
determining data of interaction made by the target user with previously shared information published by the target friend;
determining an influence degree of the target friend on interaction to be made by the target user with the target recommended information based on the data of interaction made by the target user with the previously shared information published by the target friend;
determining a target influence degree based on the influence degree of the target friend on the interaction to be made by the target user with the target recommended information;
determining a probability degree of the interaction to be made by the target user with the target recommended information based on the target influence degree; and
pushing the target recommended information to the target user in response to the probability degree meeting a preset condition.

2. The information recommendation method according to claim 1, wherein:
the data of interaction made by the target user with the previously shared information published by the target friend has a linear relationship with the influence degree of the target friend on the interaction to be made by the target user with the target recommended information; and
the determining the influence degree of the target friend on the interaction to be made by the target user with the target recommended information based on the data of interaction made by the target user with the previously shared information published by the target friend, comprises:
determining the influence degree of the target friend on the interaction to be made by the target user with the target recommended information based on the linear relationship and the data of interaction made by the target user with the previously shared information published by the target friend.

3. The information recommendation method according claim 2, wherein the determining the influence degree of the target friend on the interaction to be made by the target user with the target recommended information based on the linear relationship and the data of interaction made by the target user with the previously shared information published by the target friend, comprises:
determining the influence degree of the target friend j on the interaction to be made by the target user i with the target recommended information, according to an equation cᵢⱼ=w·nᵢⱼ+b, wherein cᵢⱼ is the influence degree of the target friend j on the interaction to be made by the target user i with the target recommended information, nᵢⱼ is the number of interactions made by the target user i with the previously shared information published by the target friend j, w is a preset interaction weight, and b is a preset constant.

4. The information recommendation method according to claim 3, wherein a process of determining the w and the b comprises:
pushing a plurality of pieces of the recommended information to a user and the target friend;
counting the number of interactions made by the target friend with the plurality of pieces of the recommended information, and the number of interactions made by the user with the recommended information with which the target friend has interacted;
determining a ratio of the number of interactions made by the user with the recommended information with which the target friend has interacted, to the number of interactions made by the target friend with the plurality of pieces of the recommended information, as a sample value cₛₐₘₚₗₑ of the influence degree of the target friend on the interaction to be made by the user with the recommended information;
acquiring the number nₛₐₘₚₗₑ of history interactions made by the user with the previously shared information published by the target friend; and
determining the w and the b by performing a multiple regression analysis algorithm on the sample value cₛₐₘₚₗₑ of the influence degree and the number nₛₐₘₚₗₑ of history interactions.

5. The information recommendation method according to claim 3, wherein
the nᵢⱼ comprises a set of the numbers of interactions of all preset types made by the target user i with the previously shared information published by the target friend j and
the w comprises a set of the weights of all the preset types.

6. The information recommendation method according to claim 3, wherein the determining the target influence degree based on the influence degree of the target friend on the interaction to be made by the target user with the target recommended information, comprises:
determining the target influence degree according to an equation
$$InfluScore = {\sum }_{j ∈ N} {c}_{ij} ,$$
wherein InfluScore is the target influence degree, and N is the number of the target friend who has interacted with the target recommended information among the one or more friends of the target user; or
determining the target influence degree according to an equation InfluScore=newcᵢⱼ+f·Incluscore_old, wherein InfluScore is the target influence degree, newcᵢⱼ is an influence degree of the target friend who made the latest interaction with the target recommended information, on the interaction to be made by the target user with the target recommended information, f is a current time attenuation factor, and InfluScore_old is a sum of influence degrees of other target users.

7. The information recommendation method according to claim 4, wherein the determining the target influence degree based on the influence degree of the target friend on the interaction to be made by the target user with the target recommended information, comprises:
determining the target influence degree according to an equation
$$InfluScore = {\sum }_{j ∈ N} {c}_{ij} ,$$
wherein InfluScore is the target influence degree, and N is the number of the target friend who has interacted with the target recommended information among the one or more friends of the target user; or
determining the target influence degree according to an equation InfluScore=newcᵢⱼ+f·Incluscore_old, wherein InfluScore is the target influence degree, newcᵢⱼ is an influence degree of the target friend who made the latest interaction with the target recommended information, on the interaction to be made by the target user with the target recommended information, f is a current time attenuation factor, and InfluScore_old is a sum of influence degrees of other target users.

8. The information recommendation method according to claim 5, wherein the determining the target influence degree based on the influence degree of the target friend on the interaction to be made by the target user with the target recommended information, comprises:
determining the target influence degree according to an equation
$$InfluScore = {\sum }_{j ∈ N} {c}_{ij} ,$$
wherein InfluScore is the target influence degree, and N is the number of the target friend who has interacted with the target recommended information among the one or more friends of the target user; or
determining the target influence degree according to an equation InfluScore=newcᵢⱼ+f·Incluscore_old, wherein InfluScore is the target influence degree, newcᵢⱼ is an influence degree of the target friend who made the latest interaction with the target recommended information, on the interaction to be made by the target user with the target recommended information, f is a current time attenuation factor, and InfluScore_old is a sum of influence degrees of other target users.

9. The information recommendation method according to claim 1, wherein the determining the probability degree of the interaction to be made by the target user with the target recommended information based on the target influence degree, comprises:
determining an interest level of the target user in the target recommended information, and
determining the probability degree of the interaction to be made by the target user with the target recommended information based on the interest level and the target influence degree.

10. The information recommendation method according to claim 9, wherein determining that the probability degree meets the preset condition, comprises:
determining that the probability degree meets the preset condition in a case that the probability degree is greater than a preset probability degree; or
ranking each candidate recommended information comprising the target recommended information based on the probability degree corresponding to each candidate recommended information, after determining the probability degree of the interaction to be made by the target user with each candidate recommended information, and determining that the probability degree meets the preset condition in a case that a rank of the target recommended information meets a preset rank condition.

11. An information recommendation apparatus, comprising one or more processors and storage mediums storing instructions, wherein the one or more processors are configured to execute the instructions stored in the storage medium to perform the following method:
determining a target friend who has interacted with target recommended information among one or more friends of a target user;
determining data of interaction made by the target user with previously shared information published by the target friend;
determining an influence degree of the target friend on interaction to be made by the target user with the target recommended information based on the data of interaction made by the target user with the previously shared information published by the target friend;
determining a target influence degree based on the influence degree of the target friend on the interaction to be made by the target user with the target recommended information;
determining a probability degree of the interaction to be made by the target user with the target recommended information based on the target influence degree; and
pushing the target recommended information to the target user in response to the probability degree meeting a preset condition.

12. The information recommendation apparatus according to claim 11, wherein:
the data of interaction made by the target user with the previously shared information published by the target friend has a linear relationship with the influence degree of the target friend on the interaction to be made by the target user with the target recommended information; and
the method further comprises:
determining the influence degree of the target friend on the interaction to be made by the target user with the target recommended information based on the linear relationship and the data of interaction made by the target user with the previously shared information published by the target friend.

13. The information recommendation apparatus according to claim 12, wherein the method further comprises:
determining the influence degree of the target friend j on the interaction to be made by the target user i with the target recommended information, according to an equation cᵢⱼ=w·nᵢⱼ+b, wherein cᵢⱼ is the influence degree of the target friend j on the interaction to be made by the target user i with the target recommended information, nᵢⱼ is the number of interactions made by the target user i with the previously shared information published by the target friend j, w is a preset interaction weight, and b is a preset constant.

14. The information recommendation apparatus according to claim 13, wherein the method further comprises:
determining the target influence degree according to an equation
$$InfluScore = {\sum }_{j ∈ N} {c}_{ij} ,$$
wherein InfluScore is the target influence degree, and N is the number of the target friend who has interacted with the target recommended information among the one or more friends of the target user; or
determining the target influence degree according to an equation InfluScore=newcᵢⱼ+f·Incluscore_old, wherein InfluScore is the target influence degree, newcᵢⱼ is an influence degree of the target friend who made the latest interaction with the target recommended information, on the interaction to be made by the target user with the target recommended information, f is a current time damping factor, and InfluScore_old is a sum of influence degrees of other target users.

15. A sever, comprising an information recommendation apparatus comprising one or more processors and storage mediums storing instructions, wherein the processor is configured to execute the instructions stored in the storage medium to perform the following method:
determining a target friend who has interacted with target recommended information among one or more friends of a target user;
determining data of interaction made by the target user with previously shared information published by the target friend;
determining an influence degree of the target friend on interaction to be made by the target user with the target recommended information based on the data of interaction made by the target user with the previously shared information published by the target friend;
determining a target influence degree based on the influence degree of the target friend on the interaction to be made by the target user with the target recommended information;
determining a probability degree of the interaction to be made by the target user with the target recommended information based on the target influence degree; and
pushing the target recommended information to the target user in response to the probability degree meeting a preset condition.

16. The sever according to claim 15, wherein:
the data of interaction made by the target user with the previously shared information published by the target friend has a linear relationship with the influence degree of the target friend on the interaction to be made by the target user with the target recommended information; and
the method further comprises:
determining the influence degree of the target friend on the interaction to be made by the target user with the target recommended information based on the linear relationship and the data of interaction made by the target user with the previously shared information published by the target friend.

17. The sever according to claim 16, wherein the method further comprises:
determining the influence degree of the target friend j on the interaction to be made by the target user i with the target recommended information, according to an equation cᵢⱼ=w·nᵢⱼ+b, wherein cᵢⱼ is the influence degree of the target friend j on the interaction to be made by the target user i with the target recommended information, nᵢⱼ is the number of interactions made by the target user i with the previously shared information published by the target friend j, w is a preset interaction weight, and b is a preset constant.

18. The sever according to claim 17, wherein the method further comprises:
determining the target influence degree according to an equation
$$InfluScore = {\sum }_{j ∈ N} {c}_{ij} ,$$
wherein InfluScore is the target influence degree, and N is the number of the target friend who has interacted with the target recommended information among the one or more friends of the target user; or
determining the target influence degree according to an equation InfluScore=newcᵢⱼ+f·Incluscore_old, wherein InfluScore is the target influence degree, newcᵢⱼ is an influence degree of the target friend who made the latest interaction with the target recommended information, on the interaction to be made by the target user with the target recommended information, f is a current time damping factor, and InfluScore_old is a sum of influence degrees of other target users.
